(19) United States
(12) Patent Application Publication
(10) Pub. No.: US 2008/0303403 A1
(43) Pub. Date: Dec. 11, 2008

(54) Magnetic Light

(76) Inventor: Jin Li, Guangdong (CN)

Correspondence Address: DAVID AND RAYMOND PATENT FIRM, 108 N. YNEZ AVE., SUITE 128, MONTEREY PARK, CA, 91754, US

(21) Appl. No.: 10/586,404

(22) PCT Filed: Dec. 20, 2005
(86) PCT No.: PCT/CN2005/002257

§ 371 Date: Jul. 18, 2006

(30) Foreign Application Priority Data
Apr. 22, 2005 (CN) 200510034411.3

(51) Int. Cl. H01J 1/62

(52) U.S. Cl. 313/485

(57) ABSTRACT

The present invention discloses a magnetic light, including an air-filled light body having an inner cavity, at least a through slot defined on the light body, and a fluorescent layer coated onto said inner cavity. A magnetic body is penetrating through the through slot for providing high frequency resonance purposes for replacing conventional filament so as to improve the efficiency and life span of the light.

### BACKGROUND OF THE PRESENT INVENTION

1. Field of Invention

The present invention relates to luminous means, and more particularly, relates to a kind of magnetic light having a through opened light body for accommodating a magnetic body, which is adapted to activate fluorescent powder coated onto the light body for shining up the light.

2. Description of Related Arts

The current illuminating lights could be categorized into incandescent lights and fluorescent lights, both of which comprising an air-filled cavity, a plurality of filaments received within the cavity to be charged for luminous purposes. Therefore, the life-span of the lights would be depended onto the quality of the filaments. However, the filaments had been widely considered as the insurmountable hindrance for enhancing the overall durability of the illuminating lights. On the other hand, magnetic lights utilize high-frequency magnetic energy resonance theory to replace conventional filament illumination theory, which employs LC series filaments having fluorescent electrode, wherein the electrode could be heated to activate fluorescent powder for illumination. By applying the magnetic lights, the luminous efficiency would be significantly improved as much as 20% and the fluorescent light-attenuating phenomena could be neglected. And more importantly, the life-span of the light could be extended 16 times, the energy-saving efficiency could be increased around 35-45%, and the input efficiency could achieve 6W-1500W.

### SUMMARY OF THE PRESENT INVENTION

A primary object of the present invention is to ameliorate the shortcomings of the conventional luminous lights, and meanwhile provide a kind of magnetic light having extended life-span, wherein such magnetic light utilizes magnetic resonance techniques for activating the fluorescent powder so as to replace filament illuminating means of conventional luminous lights.

Accordingly, to achieve above mentioned object, the present invention provides a magnetic light, comprising a light body having an air-filled inner cavity, and at least a through slot, wherein a fluorescent layer is coated onto the inner cavity.

The light body further comprises a glass tube communicating with the through slot.

The glass tube is extended into the air-filled inner cavity for storing mercury therein.

The light body of the present invention further comprises an air guiding tube for filling and discharging air to the inner cavity.

It is noted that the through slot defined onto the light body is positioned at one end of the light body.

It is noted that the light body has two through slots respectively provided at opposite ends of the light body.

It is noted that the light body of the present invention could be defined as elliptic shape, rectangle shape, round shape, cylinder shape, oblate shape, flat panel shape, ring shape and tubular shape.

It is noted that the through slot could be round shape, oblate shape, rectangle shape, as well as polygonal shape.

It is noted that the light body comprises at least glass tube.

Accordingly, the magnetic light prepared by the present invention has a simpler structure, a lowered cost, and a significantly improved electromagnetic inductivity as much as 2-4 times compared with conventional lights.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a magnetic light according to a preferred embodiment of the present invention.

FIG. 2 is a side sectional view of the above magnetic light according to the preferred embodiment of the present invention.

FIG. 3 is a schematic view of a magnetic light according to a second embodiment of the present invention.

FIG. 4 is a side sectional view of the magnetic light according to the second embodiment of the present invention.

FIG. 5 is a schematic view of a magnetic light according to a third embodiment of the present invention.

FIG. 6 is a schematic view showing a magnetic body penetrating through the through slot of the light body according to the present invention.

### DETAILED DESCRIPTION OF THE PREFERRED EMBODIMENT

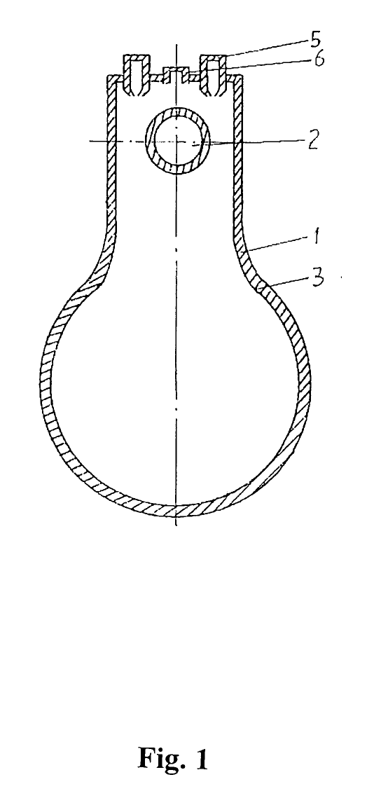

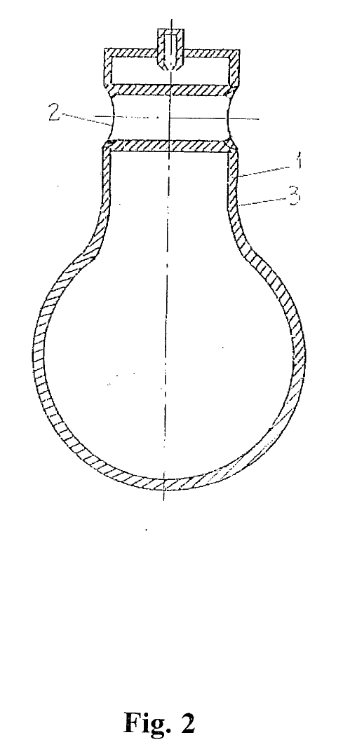

Referring to FIG. 1 and FIG. 2, a magnetic light according to a preferred embodiment of the present invention is illustrated, wherein the magnetic light comprises an air-filled light body 1 having a through slot 2 defined thereon, a fluorescent layer 3 coated onto an inner cavity of the light body 1, wherein the through slot 3 is defined at one end of the light body 1. Whenever in application, a magnetic body is penetrated through the through slot 3 for utilizing high frequency magnetic energy resonance to shine the light body thus ultimately replacing energy-wasting filaments.

According to the present invention, the light body 1 further comprises two glass tubes 5 extended into light body to communicate with the inner cavity of the light body and to store mercury within the glass tubes 5. Furthermore, the light body 1 further comprises an air guiding tube for filling and discharging air to the light body 1.

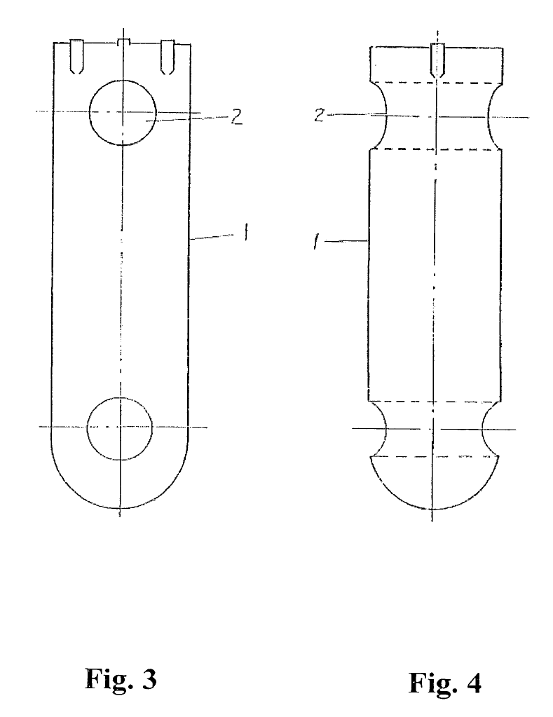

As shown in FIG. 3 and FIG. 4, a magnetic light according to a second embodiment of the present invention is illustrated. The magnetic light comprises an air-filled light body 1 having two through slots 2 defined thereon, and a fluorescent layer coated onto an inner cavity of the light body 1, wherein the through slots 2 are respectively disposed at opposite ends of the light body 1.

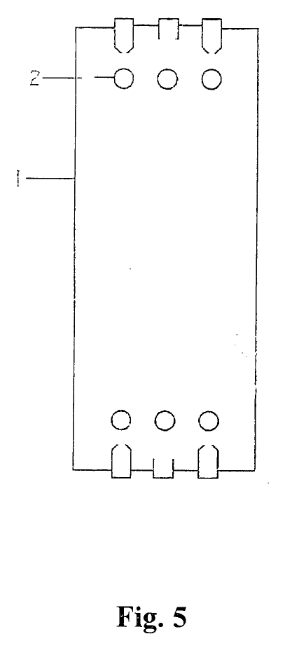

As shown in FIG. 5, a magnetic light according to a third embodiment of the present invention is illustrated. The magnetic light comprises an air-filled light body 1 having six through slots defined thereon, a fluorescent layer coated onto an inner cavity of the light body, wherein the through slots are evenly and respectively disposed at opposite ends of the light body 1.

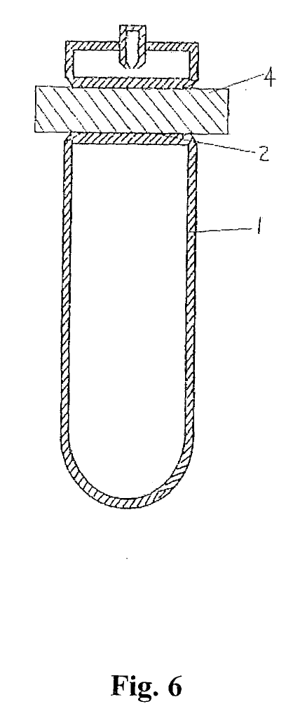

FIG. 6 is a schematic view showing a magnetic body penetrating through the through slot of the light body according to the present invention. The magnetic light comprises an air-filled light body having a through slot 2 defined thereon, wherein a fluorescent layer is coated onto an inner cavity of the light body 1; a magnetic body 4 is disposed penetrating the light body via the through slot for high frequency resonance purposes. As a result, conventional filament could be replaced by such magnetic body 4.

In applications, the magnetic body 4 is penetrating through the light body 1 via the trough slot, and the high frequency resonance mechanism is employed for replacing conventional filaments to shine up the light body. As a result, the luminous efficiency would be significantly improved as much as 20% and the fluorescent light-attenuating phenomena could be neglected. And more importantly, the life-span of the light could be extended 16 times compared with conventional fluorescent light, the energy-saving efficiency could be increased as much as 35-45%, and the input efficiency could achieve 6W-1500W.

According to the present invention, the through slot 2 could be disposed at one end of the light body, or respectively disposed at opposite ends of the light body.

Finally, it is noted that the light body of the present invention could be defined as elliptic shape, rectangle shape, round shape, cylinder shape, oblate shape, flat panel shape, ring shape, tubular shape and abnormal shape. It is noted that the through slot could be round shape, oblate shape, rectangle shape, polygonal shape and abnormal shape.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A magnetic light, comprising:
an air-filled light body having an inner cavity, at least a through slot defined thereon, and a fluorescent layer coated onto said inner cavity.

2. The magnetic light, as recited in claim 1, wherein said light body further comprises a glass tube communicated with said inner cavity.

3. The magnetic light, as recited in claim 2, wherein said glass tube is extended into said inner cavity.

4. The magnetic light, as recited in claim 1, wherein said light body further lo comprises an air guiding tube.

5. The magnetic light, as recited in claim 1, wherein said light body has a through slot disposed at one end of said light body.

6. The magnetic light, as recited in claim 1, wherein said light body has a pair of through slots respectively disposed at opposite ends of said light body.

7. The magnetic light, as recited in claim 1 to claim 6, wherein said light body is selected from a group consisting of round shape body, oblate shape body, rectangle shape body, cylinder shape body, elliptical shape body, flat panel body, ring shape body and tubular shape body.

8. The magnetic light, as recited in claim 1 to claim 6, wherein said through slot is selected from a group consisting of light body is selected from a group consisting of round shape slot, oblate shape slot, rectangle shape slot, and polygonal shape slot.

9. The magnetic light, as recited in claim 2 and claim 3, wherein said light body further comprises at least a glass tube.
